(19) United States
(12) Patent Application Publication
(10) Pub. No.: US 2026/0014881 A1
(43) Pub. Date: Jan. 15, 2026

(54) APPARATUS FOR WIRELESSLY TRANSMITTING POWER TO A VEHICLE WHILE STOPPED OR DRIVING

(71) Applicant: WIPOWERONE.INC, Daejeon (KR)

(72) Inventors: Kyo-Il LEE, Daejeon (KR); Dong-Ho Cho, Daejeon (KR); Tae-Yeon Lee, Daejeon (KR)

(21) Appl. No.: 19/335,192

(22) Filed: Sep. 22, 2025

Related U.S. Application Data
(63) Continuation of application No. PCT/KR2024/003487, filed on Mar. 20, 2024.

(30) Foreign Application Priority Data
Mar. 20, 2023 (KR) 10-2023-0035722

(51) Int. Cl. B60L 53/122; B60L 53/62; H02J 50/00; H02J 50/10; H02J 50/40

(52) U.S. Cl. CPC B60L 53/122; B60L 53/62; H02J 50/005; H02J 50/10; H02J 50/402

(57) ABSTRACT

An apparatus for wirelessly transmitting power to a vehicle that is stopped or driving is provided. The wireless power transfer apparatus includes multi-phase, multi-layer coils arranged in the direction of travel of the vehicle. By adjusting the phase of the current supplied to adjacently arranged wireless power transfer coil modules, the continuity and stability of power reception are improved, enabling a uniform power supply to the moving vehicle. This enhances the application range and reliability of the wireless power transfer apparatus.

### BACKGROUND OF THE INVENTION

### 1. Field of the Invention

The present invention relates to an apparatus for wirelessly transmitting power to a vehicle while stopped or driving. More specifically, the present invention relates to a wireless power transfer apparatus that optimizes the shape of a magnetic field formed by adjacently arranged wireless power transfer coils, where wireless power transfer apparatuses equipped with multi-phase, multi-layer coils are arranged along a direction of travel of a vehicle, such as an electric vehicle or industrial equipment.

### 2. Description of the Related Art

Wireless power transfer technology has become an important technology for continuously supplying power to vehicles, such as electric vehicles and industrial equipment. In particular, a method using multi-phase, multi-layer coils has the advantage of significantly improving the efficiency and range of power transfer. This coil configuration allows for a high power transfer rate and a wider transfer range while minimizing spatial constraints. Furthermore, a multi-phase configuration makes the power supply more stable, allowing a wireless power receiving apparatus to efficiently receive power without being limited to a specific position on the coil.

International Publication No. WO 2023/149773 discloses a wireless power transfer system that utilizes the advantages of such multi-phase, multi-layer coils. The patent focuses on a method for improving the efficiency of power transfer and reducing energy loss during the transfer process by using multi-layer coils. This presents a significant improvement, particularly in power transfer from a fixed position to a vehicle.

However, the aforementioned invention mainly describes a system based on a single multi-layer coil module, which has several limitations in terms of effectively supplying power to a driving vehicle. Particularly, when a vehicle is driving, ensuring the continuity and stability of power reception becomes more important, but it is difficult to meet these requirements only a single coil module configuration. To maximize the power transfer efficiency for a moving vehicle, a method is needed that can effectively manage the strength and distribution of the magnetic field, which changes along the path of travel.

### SUMMARY OF THE INVENTION

An object of the present invention is to solve the problems described above, and more specifically, to resolve the discontinuity and instability of power reception that can occur when using two or more adjacently arranged, multi-phase, multi-layer coil modules while a vehicle is driving.

To solve the problems described above, the present invention provides a wireless power transfer apparatus. The apparatus comprises two or more wireless power transfer coil modules arranged adjacently in a direction of travel of a vehicle; and a controller configured to adjust a phase of a current supplied to each of the two or more adjacently arranged wireless power transfer coil modules according to a coil type of the wireless power transfer coil modules.

In one embodiment, the wireless power transfer coil module may comprise a unipolar type coil, and in this case, the controller is configured to control currents supplied to adjacently arranged unipolar type coils to have a phase difference of 180 degrees from each other. In another embodiment, the wireless power transfer coil module may comprise a bipolar type coil having two coils disposed in a direction perpendicular to the direction of travel of the vehicle, and the controller is configured to control currents supplied to adjacently arranged bipolar type coils to have a phase difference of 0 degrees from each other. In yet another embodiment, the wireless power transfer coil module may comprise a bipolar type coil having two coils disposed in a direction parallel to the direction of travel of the vehicle, and the controller is configured to control currents supplied to adjacently arranged bipolar type coils to have a phase difference of 180 degrees from each other.

The wireless power transfer coil module may be a single layer. Alternatively, the wireless power transfer coil module may have two or more layers. For instance, a two-layer module may be formed by stacking a unipolar type coil and a bipolar type coil. A two-layer module may also be formed by stacking a first bipolar type coil, having two coils disposed in a direction perpendicular to the direction of travel of the vehicle, and a second bipolar type coil, having two coils disposed in a direction parallel to the direction of travel of the vehicle. Furthermore, a three-layer module may be formed by stacking a unipolar type coil, a first bipolar type coil, and a second bipolar type coil.

The vehicle may be an electric vehicle or industrial equipment.

According to the present invention, a uniform supply of power is possible regardless of the position or speed of the vehicle, thereby further improving the application range and reliability of wireless power transfer technology.

### BRIEF DESCRIPTION OF THE DRAWINGS

FIG. 1A is a diagram schematically illustrating an embodiment in which single-layer, unipolar type wireless power transfer coil modules are arranged along a direction of travel of a vehicle, indicated by an arrow.

FIG. 1B is a diagram illustrating the magnetic field strength in a boundary region between two modules when the phase difference of currents supplied to the unipolar type wireless power transfer coil modules shown in FIG. 1A is varied.

FIG. 2A is a diagram schematically illustrating an embodiment in which single-layer, bipolar type wireless power transfer coil modules are arranged along a direction of travel of a vehicle, indicated by an arrow, wherein the two coils of each wireless power transfer coil are arranged in a direction perpendicular to the direction of travel of the vehicle.

FIG. 2B is a diagram illustrating the magnetic field strength in a boundary region between two modules when the phase difference of currents supplied to the bipolar type wireless power transfer coil modules shown in FIG. 2A is varied.

FIG. 3A is a diagram schematically illustrating an embodiment in which single-layer, bipolar type wireless power transfer coil modules are arranged along a direction of travel of a vehicle, indicated by an arrow, wherein the two coils of each wireless power transfer coil are arranged in a direction parallel to the direction of travel of the vehicle.

FIG. 3B is a diagram illustrating the magnetic field strength in a boundary region between two modules when the phase difference of currents supplied to the bipolar type wireless power transfer coil modules shown in FIG. 3A is varied.

FIG. 4A is a diagram schematically illustrating an embodiment in which two-layer wireless power transfer coil modules are arranged along a direction of travel of a vehicle, indicated by an arrow, wherein the wireless power transfer coil module is formed by stacking the unipolar type coil of FIG. 1A and the bipolar type coil of FIG. 2A.

FIG. 4B is a diagram schematically illustrating an embodiment in which two-layer wireless power transfer coil modules are arranged along a direction of travel of a vehicle, indicated by an arrow, wherein the wireless power transfer coil module is formed by stacking the unipolar type coil of FIG. 1A and the bipolar type coil of FIG. 3A.

FIG. 4C is a diagram schematically illustrating an embodiment in which two-layer wireless power transfer coil modules are arranged along a direction of travel of a vehicle, indicated by an arrow, wherein the wireless power transfer coil module is formed by stacking the bipolar type coil of FIG. 2A and the bipolar type coil of FIG. 3A.

FIG. 4D is a diagram schematically illustrating an embodiment in which a three-layer wireless power transfer coil module is arranged along a direction of travel of a vehicle, indicated by an arrow, wherein the wireless power transfer coil module is formed by stacking the unipolar type coil of FIG. 1A, the bipolar type coil of FIG. 2A, and the bipolar type coil of FIG. 3A.

### DETAILED DESCRIPTION OF THE INVENTION

Hereinafter, embodiments according to the present invention will be described in detail with reference to the accompanying drawings. Identical or similar components are given the same or similar reference numerals, and redundant descriptions thereof will be omitted. In describing the embodiments disclosed herein, if it is determined that a detailed description of a related known technology may obscure the gist of the embodiments disclosed herein, the detailed description thereof will be omitted. The accompanying drawings are for the purpose of facilitating an easy understanding of the embodiments disclosed herein, and it should be understood that the technical ideas disclosed herein are not limited by the accompanying drawings, and that the scope of the invention s all modifications, equivalents, and substitutes included in the spirit and scope of the present invention.

Terms including ordinal numbers, such as “first,” “second,” etc., may be used to describe various components, but these terms are only used for the purpose of distinguishing one component from another, and the components are not limited by these terms.

A singular expression includes a plural expression unless the context clearly indicates otherwise.

The terms “comprise,” “include,” “have,” etc., as used herein, should be understood to specify the presence of stated features, steps, components, or combinations thereof, and not to preclude the presence or addition of one or more other features, steps, components, or combinations thereof.

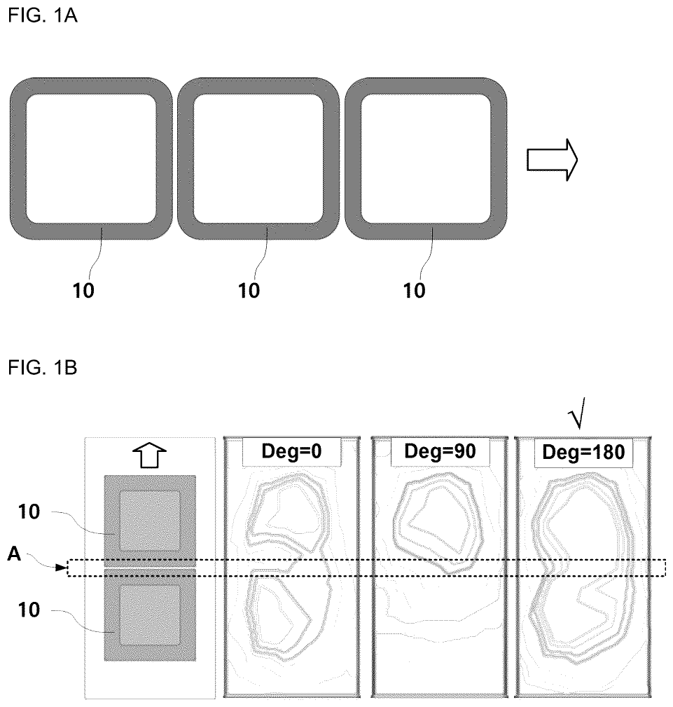

FIGS. 1A and 1B illustrate a wireless power transfer coil module according to an embodiment of the present invention. FIG. 1A is a diagram schematically illustrating an embodiment in which single-layer, unipolar type wireless power transfer coil modules are arranged along a direction of travel of a vehicle, indicated by an arrow, and FIG. 1B is a diagram illustrating the magnetic field strength in a boundary region between two modules when the phase difference of currents supplied to the unipolar type wireless power transfer coil modules shown in FIG. 1A is varied.

As illustrated, in this embodiment, unipolar type wireless power transfer coils (10), which have a generally circular shape, are arranged along the direction of travel of the vehicle, indicated by an arrow. In this arrangement, the shape of the magnetic field that is formed varies according to the phase difference of the currents supplied to two adjacently arranged wireless power transfer coils (10). FIG. 1B illustrates the shapes of the magnetic field when the phase difference between the two currents is zero (0) degrees, 90 degrees, and 180 degrees.

In FIG. 1B, reference numeral A denotes a region between the two adjacently arranged unipolar type wireless power transfer coils (10). As shown, when the phase difference of the currents supplied to the two adjacently arranged coils is 180 degrees, the resulting magnetic field exhibits a high intensity over the widest area. Furthermore, the strength of the magnetic field is maintained strongly even in the region A between the coils.

Taking this into consideration, it is preferable that a controller (not shown), such as an inverter, sets the phase difference of the currents supplied to the two adjacently arranged unipolar type wireless power transfer coils to 180 degrees. However, it is apparent to those skilled in the art that the shape of the magnetic field and the optimal phase difference may vary depending on the specific physical conditions of each wireless power transfer coil.

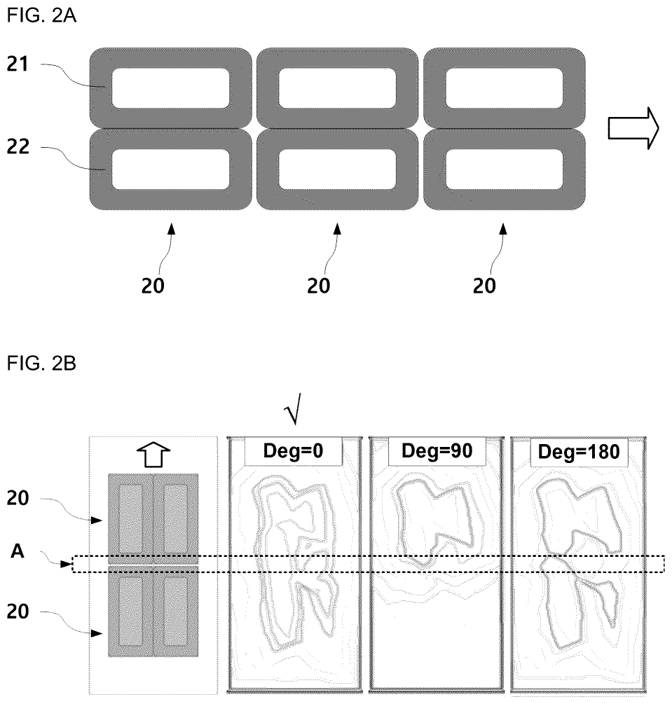

FIGS. 2A and 2B illustrate a wireless power transfer coil module according to another embodiment of the present invention. FIG. 2A is a diagram schematically illustrating an embodiment in which single-layer, bipolar type wireless power transfer coil modules are arranged along a direction of travel of a vehicle, indicated by an arrow, and FIG. 2B is a diagram illustrating the magnetic field strength in a boundary region between two modules when the phase difference of currents supplied to the bipolar type wireless power transfer coil modules shown in FIG. 2A is varied.

As illustrated, in this embodiment, bipolar type wireless power transfer coil modules (20), which have a generally DD shape, are arranged along the direction of travel of the vehicle, indicated by an arrow. The two coils (21, 22) of each wireless power transfer coil module (20) are arranged in a direction perpendicular to the direction of travel of the vehicle, indicated by the arrow. In this arrangement, the shape of the magnetic field that is formed varies according to the phase difference of the currents supplied to two adjacently arranged wireless power transfer coil modules (20). FIG. 2B illustrates the shapes of the magnetic field when the phase difference between the two currents is zero (0) degrees, 90 degrees, and 180 degrees.

In FIG. 2B, reference numeral A denotes a region between the two adjacently arranged wireless power transfer coil modules (20). As shown, when the phase difference of the currents supplied to the two adjacently arranged coil modules is zero (0) degrees, the resulting magnetic field exhibits a high intensity over the widest area. Furthermore, the strength of the magnetic field is maintained strongly even in the region A between the coils.

Taking this into consideration, it is preferable that a controller (not shown), such as an inverter, sets the phase difference of the currents supplied to the two adjacently arranged bipolar type wireless power transfer coil modules to zero (0) degrees. However, it is apparent to those skilled in the art that the shape of the magnetic field and the optimal phase difference may vary depending on the specific physical conditions of each wireless power transfer coil.

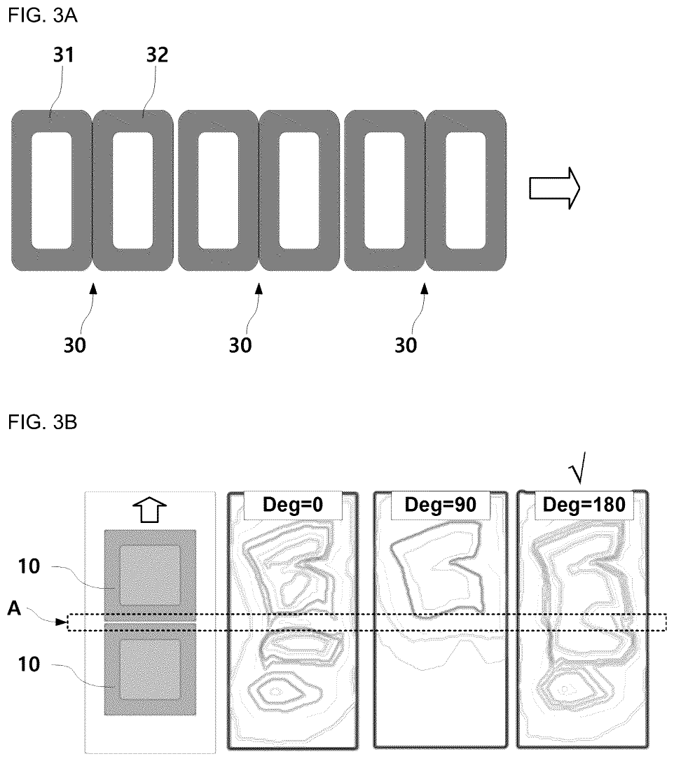

FIGS. 3A and 3B illustrate a wireless power transfer coil module according to another embodiment of the present invention. FIG. 3A is a diagram schematically illustrating an embodiment in which single-layer, bipolar type wireless power transfer coil modules are arranged along a direction of travel of a vehicle, indicated by an arrow, and FIG. 3B is a diagram illustrating the magnetic field strength in a boundary region between two modules when the phase difference of currents supplied to the bipolar type wireless power transfer coil modules shown in FIG. 3A is varied.

As illustrated, in this embodiment, bipolar type wireless power transfer coil modules (30), which have a generally DD shape, are arranged along the direction of travel of the vehicle, indicated by an arrow. The two coils (31, 32) of each wireless power transfer coil module (30) are arranged in a direction parallel to the direction of travel of the vehicle, indicated by the arrow. In this arrangement, the shape of the magnetic field that is formed varies according to the phase difference of the currents supplied to two adjacently arranged wireless power transfer coil modules (30). FIG. 3B illustrates the shapes of the magnetic field when the phase difference between the two currents is zero (0) degrees, 90 degrees, and 180 degrees.

In FIG. 3B, reference numeral A denotes a region between the two adjacently arranged wireless power transfer coil modules (30). As shown, when the phase difference of the currents supplied to the two adjacently arranged coil modules is 180 degrees, the resulting magnetic field exhibits a high intensity over the widest area. Furthermore, the strength of the magnetic field is maintained strongly even in the region A between the coils.

Taking this into consideration, it is preferable that a controller (not shown), such as an inverter, sets the phase difference of the currents supplied to the two adjacently arranged bipolar type wireless power transfer coil modules to zero (0) degrees. However, it is apparent to those skilled in the art that the shape of the magnetic field and the optimal phase difference may vary depending on the specific physical conditions of each wireless power transfer coil.

Meanwhile, it is known that when a unipolar type coil and a bipolar type coil are stacked, or when two bipolar type coils having shapes orthogonal to each other are stacked, the mutual inductance between the different types of coils has a value close to zero (0). That is, even if these coils are stacked in two or more layers, the interference between them can be kept very small. Taking this into consideration, in an additional embodiment of the present invention, a wireless power transfer coil module is provided in which different types of coils are stacked.

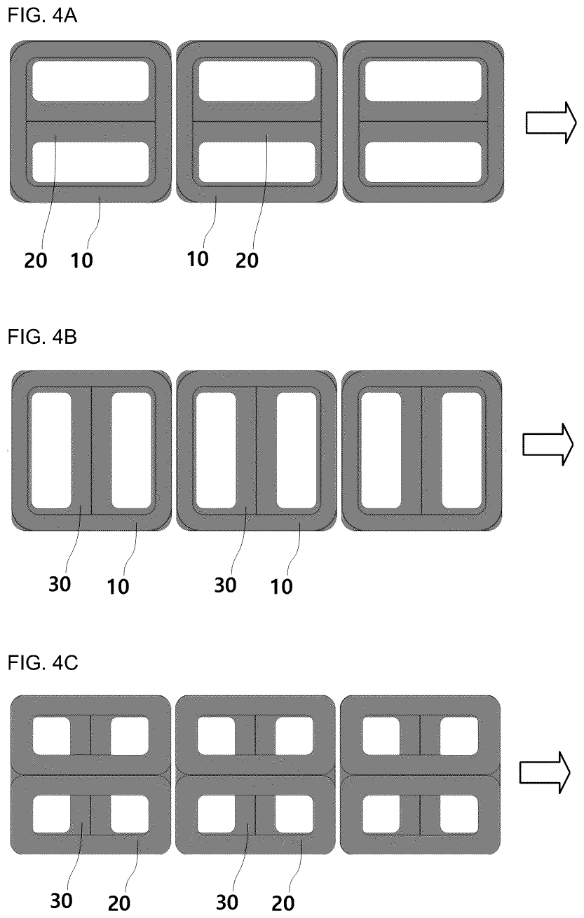

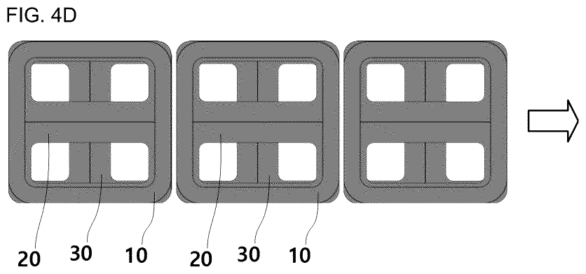

FIG. 4A is a diagram schematically illustrating an embodiment in which a two-layer wireless power transfer coil module is arranged along the direction of travel of a vehicle, indicated by an arrow, wherein the wireless power transfer coil module is in a state where the unipolar type coil shown in FIG. 1A and the bipolar type coil shown in FIG. 2A are stacked. The phase difference of the currents supplied to two adjacently arranged unipolar type coils is preferably set to 180 degrees, as described with reference to FIG. 1B, and the phase difference of the currents supplied to two adjacently arranged bipolar type coils is preferably set to zero (0) degrees, as described with reference to FIG. 2B.

FIG. 4B is a diagram schematically illustrating an embodiment in which a two-layer wireless power transfer coil module is arranged along the direction of travel of a vehicle, indicated by an arrow, wherein the wireless power transfer coil module is in a state where the unipolar type coil shown in FIG. 1A and the bipolar type coil shown in FIG. 3A are stacked. The phase difference of the currents supplied to two adjacently arranged unipolar type coils is preferably set to 180 degrees, as described with reference to FIG. 1B, and the phase difference of the currents supplied to two adjacently arranged bipolar type coils is preferably set to 180 degrees, as described with reference to FIG. 3B.

FIG. 4C is a diagram schematically illustrating an embodiment in which a two-layer wireless power transfer coil module is arranged along the direction of travel of a vehicle, indicated by an arrow, wherein the wireless power transfer coil module is in a state where the bipolar type coil shown in FIG. 2A (hereinafter, referred to as a ‘first bipolar type’ coil) and the bipolar type coil shown in FIG. 3A (hereinafter, referred to as a ‘second bipolar type’ coil) are stacked. The phase difference of the currents supplied to two adjacently arranged first bipolar type coils is preferably set to zero (0) degrees, as described with reference to FIG. 2B, and the phase difference of the currents supplied to two adjacently arranged second bipolar type coils is preferably set to 180 degrees, as described with reference to FIG. 3B.

FIG. 4D is a diagram schematically illustrating an embodiment in which a three-layer wireless power transfer coil module is arranged along the direction of travel of a vehicle, indicated by an arrow, wherein the wireless power transfer coil module is in a state where the unipolar type coil shown in FIG. 1A, the first bipolar type coil shown in FIG. 2A, and the second bipolar type coil shown in FIG. 3A are stacked. The phase difference of the currents supplied to two adjacently arranged unipolar type coils is preferably set to 180 degrees. Furthermore, the phase difference of the currents supplied to two adjacently arranged first bipolar type coils is preferably set to zero (0) degrees, as described with reference to FIG. 2B, and the phase difference of the currents supplied to two adjacently arranged second bipolar type coils is preferably set to 180 degrees, as described with reference to FIG. 3B.

The foregoing detailed description is to be considered in all respects as illustrative and not restrictive. The scope of the invention is to be determined by the reasonable interpretation of the appended claims, and all changes that come within the equivalent scope of the invention are to be embraced therein.

What is claimed is:

1. A wireless power transfer apparatus, comprising:
two or more wireless power transfer coil modules arranged adjacently in a direction of travel of a vehicle; and
a controller configured to adjust a phase of a current supplied to each of the two or more adjacently arranged wireless power transfer coil modules according to a coil type of the wireless power transfer coil modules.

2. The wireless power transfer apparatus of claim 1,
wherein the wireless power transfer coil module comprises a unipolar type coil, and
wherein the controller is configured to control currents supplied to adjacently arranged unipolar type coils to have a phase difference of 180 degrees from each other.

3. The wireless power transfer apparatus of claim 1,
wherein the wireless power transfer coil module comprises a bipolar type coil having two coils disposed in a direction perpendicular to the direction of travel of the vehicle, and
wherein the controller is configured to control currents supplied to adjacently arranged bipolar type coils to have a phase difference of 0 degrees from each other.

4. The wireless power transfer apparatus of claim 1,
wherein the wireless power transfer coil module comprises a bipolar type coil having two coils disposed in a direction parallel to the direction of travel of the vehicle, and
wherein the controller is configured to control currents supplied to adjacently arranged bipolar type coils to have a phase difference of 180 degrees from each other.

5. The wireless power transfer apparatus of claim 1, wherein the wireless power transfer coil module is a single layer.

6. The wireless power transfer apparatus of claim 1, wherein the wireless power transfer coil module has two or more layers.

7. The wireless power transfer apparatus of claim 6, wherein the wireless power transfer coil module is formed by stacking a unipolar type coil and a bipolar type coil.

8. The wireless power transfer apparatus of claim 6, wherein the wireless power transfer coil module is formed by stacking:
a first bipolar type coil having two coils disposed in a direction perpendicular to the direction of travel of the vehicle; and
a second bipolar type coil having two coils disposed in a direction parallel to the direction of travel of the vehicle.

9. The wireless power transfer apparatus of claim 6, wherein the wireless power transfer coil module is formed by stacking:
a unipolar type coil;
a first bipolar type coil having two coils disposed in a direction perpendicular to the direction of travel of the vehicle; and
a second bipolar type coil having two coils disposed in a direction parallel to the direction of travel of the vehicle.

10. The wireless power transfer apparatus of claim 1, wherein the vehicle is an electric vehicle.

11. The wireless power transfer apparatus of claim 1, wherein the vehicle is industrial equipment.
